(19) United States
(12) Patent Application Publication
(10) Pub. No.: US 2024/0378138 A1
(43) Pub. Date: Nov. 14, 2024

(54) SOFTWARE TESTING WITH MULTIPLE INSTANCES OF POLICY MANAGEMENT SYSTEM

(71) Applicant: State Farm Mutual Automobile Insurance Company, Bloomington, IL (US)

(72) Inventor: Jacob Carlson, Hudson, IL (US)

(21) Appl. No.: 18/616,710

(22) Filed: Mar. 26, 2024

Related U.S. Application Data
(60) Provisional application No. 63/465,139, filed on May 9, 2023.

(51) Int. Cl. G06F 11/36; G06F 9/455; G06F 16/955; G06Q 40/08

(52) U.S. Cl. CPC G06F 11/3664; G06F 9/455; G06F 11/3696; G06F 16/955; G06Q 40/08

(57) ABSTRACT

Different instances of a policy management system, in different clusters of a computing environment, can be configured differently for different purposes. Different policy databases, associated with the different instances of the policy management system, can store different sets of policy data that may be used or accessed during software testing or other operations via the different instances of the policy management system. A resolver can use a lookup table to track which instances of the policy management system are associated with corresponding instances of policy data. External services that access policy data during software tests and/or other operations can query the resolver to determine which instances of the policy management system to communicate with to access particular instances of policy data, such that the services can interact with differently-configured instances of the policy management system without the services themselves being reconfigured or changed.

### RELATED APPLICATIONS

This U.S. Patent Application claims priority to provisional U.S. Patent Application No. 63/465,139, entitled “SOFTWARE TESTING WITH MULTIPLE INSTANCES OF POLICY MANAGEMENT SYSTEM,” filed on May 9, 2023, the entirety of which is incorporated herein by reference.

### TECHNICAL FIELD

The present disclosure relates to testing and executing interactions between services and multiple differently-configured instances of a policy management system.

### BACKGROUND

During software development, software developers can prepare software tests that can be executed to identify bugs in software that should be fixed, to verify that software operates as expected, and/or to detect other issues with software. Such software testing may be associated with software for a policy management system that is used by an insurance company to manage policy data associated with insurance policies.

For example, an insurance company can use a computer-implemented policy management system to store information about insurance policies, create new insurance policies, change existing insurance policies, and/or otherwise manage insurance policies. Such insurance policies can include automobile insurance policies, fire insurance policies, and/or other types of insurance policies.

An insurance company can have other computer-implemented services that interact with the policy management system to access policy data. For example, the insurance company may have systems that execute numerous microservices and/or other services that use and/or access policy data through the policy management system, such as services in an agency channel used by insurance agents, services in a customer channel used by policyholders or other customers, billing services, payment services, policy renewal services, rating services, client services, call center services or other customer support services, and/or other types of services.

However, it can be difficult, time-consuming, and/or resource-intensive to implement software testing that may involve multiple different testing situations or scenarios associated with a policy management system and/or services that access policy data via that policy management system. As a first example, if a first software development team wants to execute software tests associated with a first particular testing scenario, the first software development team may reconfigure the policy management system based on the first particular testing scenario. However, this may prevent a second software development team that wants to execute software tests associated with a second particular testing scenario from executing its software tests until the first software development team has completed testing and the second software development team can reconfigure the policy management system based on the second particular testing scenario. This can prolong software development and testing times, and be an inefficient use of resources, particularly if there are additional software development teams that want to execute software tests in association with other testing scenarios.

As a second example, different instances of the policy management system can be created and configured for different testing scenarios that send outbound policy notifications and/or policy data to one or more external services that are separate from the policy management system. However, in this example, external services that are configured to send inbound policy data to the policy management system, and/or are configured to request policy data from the policy management system, may be unable to determine which instance of the policy management system to communicate with during each interaction.

As a third example, separate instances of services can be executed in association with different instances of the policy management system for different testing scenarios. For instance, a first set of services can be executed in association with a first instance of the policy management system for a first test scenario, while a second set of the same services can be separately and/or concurrently executed in association with a second instance of the policy management system for a second test scenario. The different instances of the services and/or the different instances of the policy management system can be directly configured for the different test scenarios in this example. However, separately executing different instances of the same services for different test scenarios, and/or reconfiguring the different instances of the same services for the different test scenarios, can be difficult, time-consuming, and/or resource-intensive. For example, there may be hundreds of different services that interact with an instance of the policy management system, and separately executing multiple instances of each of the hundreds of different services during software testing can use significant amounts of computing resources. Similarly, separately reconfiguring multiple instances of each of the hundreds of different services for different test scenarios can take significant time and labor.

It can similarly be difficult, time-consuming, and/or resource-intensive to execute multiple differently-configured instances of a policy management system in a production environment. For example, if different instances of a policy management system are configured differently, it may take significant amounts of time, effort, and/or computing resources to execute different versions of individual services that are configured to interact with the different instances of the policy management system, or to reconfigure the services to determine which instances of the policy management system to communicate with in different scenarios.

The example systems and methods described herein may be directed toward mitigating or overcoming one or more of the deficiencies described above.

### SUMMARY

Described herein are systems and methods by which different instances of a policy management system in different clusters of a computing environment can be configured differently for different purposes, such as different software testing purposes or different production purposes. Different policy databases, associated with the different instances of the policy management system, can store different sets of policy data that may be used or accessed via the different instances of the policy management system. A resolver can use a lookup table to track which instances of the policy management system are associated with corresponding instances of policy data. External services that access policy data, for instance during software tests or during other operations, can query the resolver to determine which instances of the policy management system to communicate with to access particular instances of policy data. Accordingly, the services can interact with differently-configured instances of the policy management system, during execution of software tests or during other operations, without the services themselves being reconfigured or changed.

According to a first aspect, a software testing system includes a plurality of clusters, a resolver, and a test manager. Different clusters in the plurality of clusters include different instances of a policy management system that are configured differently for different test scenarios, and different instances of a policy database that store different sets of policy data. The resolver maintains a lookup table indicating associations between keys associated with policy data instances, and instance identifiers, of the different instances of the policy management system, that correspond to the keys. The test manager causes, during execution of a software test associated with a particular test scenario, a service executing outside the plurality of clusters to operate in association with particular policy data, associated with a key, via a particular instance of the policy management system that is configured based on the particular test scenario. The service provides the key to the resolver, and receives a particular instance identifier corresponding to the particular instance of the policy management system from the resolver based on the lookup table. The service also performs, based on the particular instance identifier, an operation based on the particular policy data via the particular instance of the policy management system.

According to a second aspect, a computer-implemented method includes configuring different instances of a policy management system based on different configurations. The different instances of the policy management system are associated with different instances of a policy database that store different sets of policy data. The computer-implemented method also includes maintaining, by a resolver associated with the different instances of the policy management system, a lookup table. The lookup table stores pairs of keys corresponding to instances of the policy data and instance identifiers of the different instances of the policy management system. The computer-implemented method also includes receiving, by the resolver, and from a service configured to interact with the different instances of the policy management system, a key corresponding to a particular policy data instance, initiating the software test. The computer-implemented method additionally includes providing, by the resolver, a particular instance identifier that is paired with the key in the lookup table. The particular instance identifier causes the service to perform at least one operation associated with the particular policy data instance via a particular instance of the policy management system that is associated with the particular instance identifier.

According to a third aspect, one or more non-transitory computer-readable media store computer-executable instructions. The computer-executable instructions, when executed by one or more processors, cause the one or more processors to store policy data associated with a software test, corresponding to a test scenario, in an instance of a policy database. The instance of the policy database is associated with an instance of a policy management system configured based on the test scenario. The instance of the policy management system is within a plurality of different instances of the policy management system that are configured differently for different test scenarios and are associated with different instances of the policy database. A key associated with the policy data is associated with an instance identifier of the instance of the policy management system within a lookup table maintained by a resolver associated with the plurality of different instances of the policy management system. The computer-executable instructions also cause the one or more processors to initiate the software test. The software test invokes a service and causes the service to perform an operation based on the policy data associated with the key. The service provides the key to the resolver, and receives, from the resolver based on the lookup table, the instance identifier of the instance of the policy management system. The service, based on the instance identifier, performs the operation based on the policy data via the instance of the policy management system.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a computing environment that includes clusters executing different instances of a policy management system.

FIG. 2 shows a flowchart illustrating an example method for setting up a software test that invokes at least one service to interact with a particular instance of the policy management system.

FIG. 3 shows a flowchart illustrating an example method by which a service can, during a software test, perform an operation associated with policy data via an instance of the policy management system that has been configured for the software test.

FIG. 4 shows a flowchart illustrating an example method by which a service can perform an operation associated with policy data via an instance of the policy management system.

FIG. 5 shows an example system architecture for a computing system that can execute one or more elements associated with the testing environment.

### DETAILED DESCRIPTION

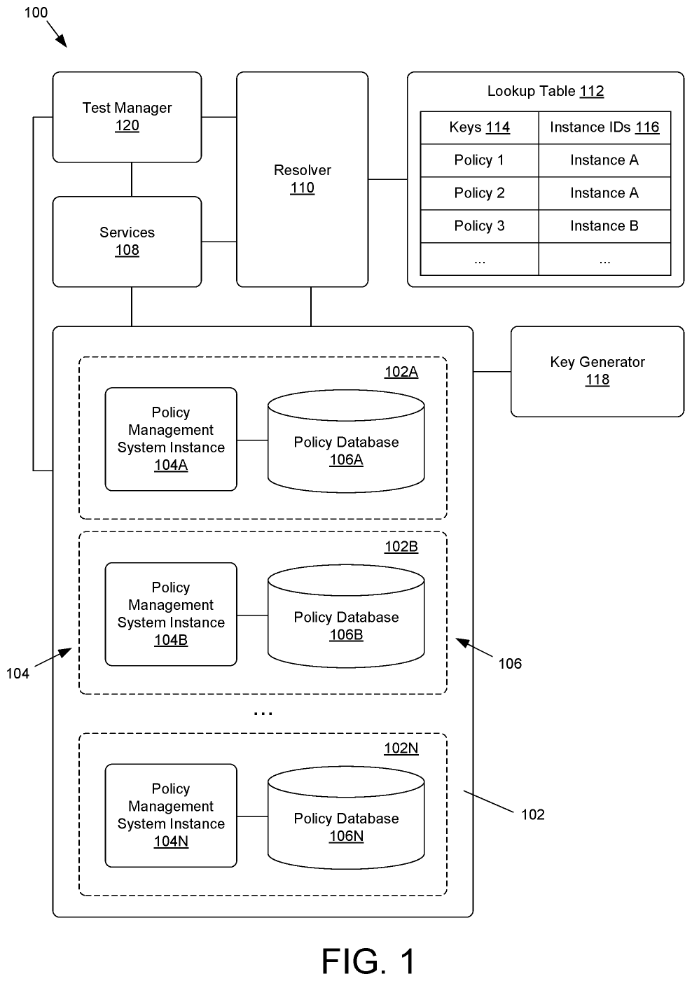

FIG. 1 shows an example of a computing environment 100 that includes clusters 102 executing different instances of a policy management system 104. The policy management system 104 can be a software application or other computer-implemented system that is configured to manage insurance policies. The insurance policies may include automobile insurance policies, fire insurance policies, and/or other types of insurance policies.

An instance of the policy management system 104 in a cluster 102 can store and/or access policy data associated with insurance policies in a corresponding instance of a policy database 106 in that cluster 102. Different instances of the policy management system 104, in different clusters 102, can accordingly store and/or access policy data in different corresponding instances of the policy database 106 that are in, or are associated with, the different clusters 102. Instances of the policy management system 104 can, for example, interact with corresponding instances of the policy database 106 to edit policy data, perform operations to process policy data, provide policy data to other services 108 and/or other elements, present user interface elements that allow users to view and/or edit policy data, and/or otherwise manage policy data associated with insurance policies.

Policy data stored in an instance of the policy database 106 can indicate information about corresponding insurance policies. For example, policy data for an automobile insurance policy can include one or more of: a client identifier, a policy number, an agreement number, an insurance company identifier, an insurance agent identifier, an address, a vehicle identifier, mandatory coverage information, vehicle use information, a guaranteed renewal status, a term, a term length, renewal dates, driver exclusions, billing methods, billing accounts, and/or other types of information. Policy data for other types of insurance policies may include similar types of information relevant to the other types of insurance policies.

Different clusters 102 can be associated with different instances of the policy management system 104, and different corresponding instances of the policy database 106. Accordingly, individual pairings of instances of the policy management system 104 and instances of the policy database 106 can be associated with distinct and independent clusters 102. The instances of the policy database 106 that are in different clusters 102 and are associated with different instances of the policy management system 104 can be distinct and separate. Accordingly, each instance of the policy database 106 can store a distinct set of policy data and can be associated with a different instance of the policy management system 104.

As shown in FIG. 1, the computing environment 100 can include any number of clusters 102, such as cluster 102A, cluster 102B, . . . and cluster 102N. Different instances of the policy management system 104, such as policy management system instance 104A, policy management system instance 104B, . . . and policy management system instance 104N shown in FIG. 1, can execute in association with different clusters 102. The different instances of the policy management system 104, associated with different clusters 102, can also be associated with corresponding instances of the policy database 106, such as policy database 106A, policy database 106B, . . . and policy database 106N as shown in FIG. 1. As an example, policy management system instance 104A and policy database 106A can be associated with cluster 102A, while policy management system instance 104B and policy database 106B can be associated with cluster 102B.

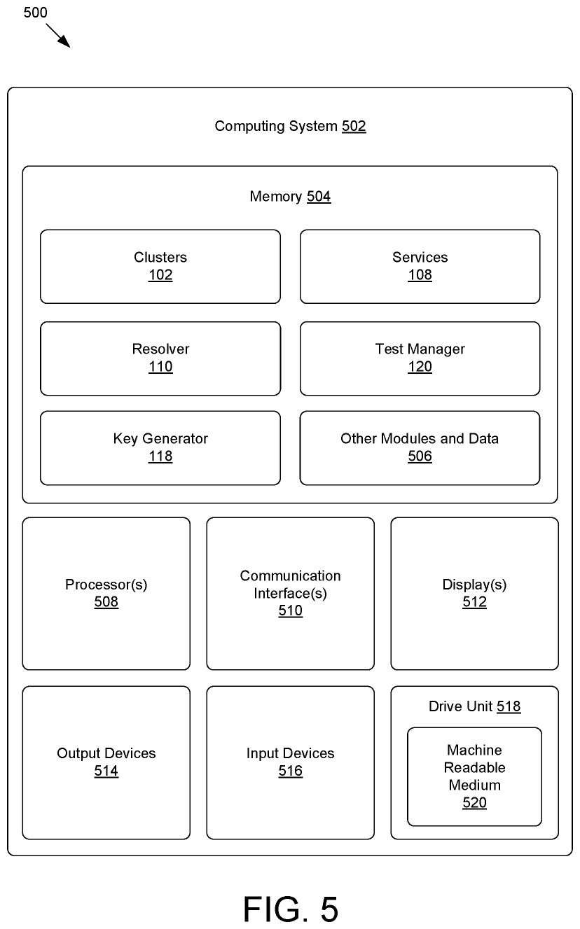

Each of the clusters 102 may be associated with, and/or be executed by, different servers and/or other different physical or virtual computing elements. For instance, in some examples different clusters 102 may be associated with different virtual machines, different containers, and/or other different computing systems or environments. An example system architecture for a computing system that may execute one or more elements of the computing environment 100, such as one or more of the clusters 102 and/or other elements described herein, is shown in FIG. 5, and is discussed further below with reference to that figure.

The different instances of the policy database 106, associated with different clusters 102 and different instances of the policy management system 104, can store distinct sets of policy data. Services 108 outside the clusters 102 may be configured to interact with any of the different instances of the policy management system 104 and thus access policy data stored in any of the different instances of the policy database 106.

Such services 108 may include upstream services 108 and/or downstream services 108. Upstream services 108 may add or edit policy data in instances of the policy database 106 by interacting with instances of the policy management system 104. Downstream services 108 can access and/or receive policy data in instances of the policy database 106 by interacting with instances of the policy management system 104. The services 108 can, for example, include services in an agency channel used by insurance agents, services in a customer channel used by policyholders or other customers, billing services, payment services, policy renewal services, rating services, client services, call center services or other customer support services, and/or other types of services. In some examples, there may be any number of different services 108 that can access policy data via instances of the policy management system 104, such as tens, hundreds, or thousands of services 108. As a non-limiting example, the services 108 can include one thousand individual microservices that operate separately and/or together, and can individually access policy data via instances of the policy management system 104.

However, the services 108 may not natively be configured with information about the clusters 102 that indicate how many clusters 102 exist, which clusters 102 store which instances of policy data, how to access policy data in particular clusters 102, and/or other information about the clusters 102. Accordingly, the clusters 102 can be associated with a resolver 110 that can direct such services 108 to particular clusters 102 that are associated with instances of policy data that the services 108 are attempting to access.

The resolver 110 can be a system node or other system entry point with which the services 108 are configured to communicate. The resolver 110 can store, access, and/or maintain a lookup table 112 that indicates pairings between keys 114 and instance identifiers 116. The keys 114 can be associated with particular instances of policy data. The instance identifiers 116 can be associated with particular instances of policy data. The lookup table 112 can accordingly indicate, for individual keys 114 that identify particular instance of policy data, which instances of the policy management system 104 store those instances of policy data in corresponding instances of the policy database 106.

When one of the services 108 is to access and/or use an instance of policy data, the service 108 can send a request to the resolver 110 that indicates a key 114 associated with the instance of policy data. The resolver 110 can return a response to the service 108 that includes the instance identifier 116 that is associated with that key 114 in the lookup table 112. Accordingly, the service 108 can access the instance of policy data associated with the key 114 by interacting with the instance of the policy management system 104 identified by the instance identifier 116 provided in the response from the resolver 110.

The keys 114 can be identifiers of instances of policy data, such as database record identifiers, policy numbers, agreement numbers, and/or other identifiers. The instance identifiers 116 can be identifiers of instances of the policy management system 104 and/or corresponding clusters 102. For example, the instance identifiers 116 can be Uniform Resource Locators (URLs) at which the instances of the policy management system 104 can be accessed by the services 108. As other examples, the instance identifiers 116 can be names, numbers, shard identifiers, and/or other identifiers of the instances of the policy management system 104 and/or the clusters 102 associated with instances of the policy management system 104.

As an example, the lookup table 112 can indicate that policy data associated with a first key (“Policy 1”) is stored in the policy database 106A of policy management system instance 104A (“Instance A”), that policy data associated with a second key (“Policy 2” is also stored in the policy database 106A of policy management system instance 104A (“Instance A”), and that policy data associated with a third key (“Policy 3”) is stored in the policy database 106B of policy management system instance 104B (“Instance B”).

Accordingly, if one of the services 108 is to access policy data associated with the first key (“Policy 1”), the service 108 can send a request with the first key to the resolver 110. Based on information in the lookup table 112 indicating that the first key (“Policy 1”) is associated with an instance identifier of policy management system instance 104A (“Instance A”), the resolver 110 can return the instance identifier of the policy management system instance 104A to the service 108. The service 108 can thus use the instance identifier of policy management system instance 104A, provided by the resolver 110, to interact with policy management system instance 104A and access the policy data associated with the first key (“Policy 1”) via policy management system instance 104A.

Similarly, if the same service 108 or a different service 108 is to access policy data associated with the third key (“Policy 3”), the service 108 can send a request with the third key to the resolver 110. Based on information in the lookup table 112 indicating that the third key (“Policy 3”) is associated with an instance identifier of policy management system instance 104B (“Instance B”), the resolver 110 can return the instance identifier of the policy management system instance 104B to the service 108. The service 108 can thus use the instance identifier of policy management system instance 104B, provided by the resolver 110, to interact with policy management system instance 104B and access the policy data associated with the third key (“Policy 3”) via policy management system instance 104B.

As discussed above, in some examples, the instance identifiers 116 can be URLs associated with corresponding instances of the policy management system 104 and/or the clusters 102 associated with the instances of the policy management system 104. Accordingly, in this example, if a service 108 provides the first key (“Policy 1”) to the resolver 110, the resolver 110 may return a first URL to the service 108 that the service 108 can use to interact with policy management system instance 104A in order to access the policy data identified by the first key (“Policy 1”). If the service 108 instead provides the third key (“Policy 3”) to the resolver 110, the resolver 110 may return a second URL to the service 108 that the service 108 can use to interact with policy management system instance 104B in order to access the policy data identified by the third key (“Policy 3”).

When instances of the policy management system 104 add new instances of policy data to corresponding instances of the policy database 106, the instances of the policy management system 104 can interact with a key generator 118 to obtain keys 114 for the newly-added instances of policy data. A key 114 associated with an instance of policy data can be an identifier associated with the instance of policy data, such as a database record identifier, policy number, agreement number, and/or other identifier. The key generator 118 can execute outside the clusters 102 and can be accessed by multiple instances of the policy management system 104. Accordingly, because keys 114 associated with policy data stored in different instances of the policy database 106 can be assigned by the external key generator 118, keys 114 can uniquely identify corresponding instances of policy data across all of the instances of the policy database 106. The key generator 118 may accordingly prevent keys 114 from being re-used or repeated across multiple instances of the policy database 106.

When an instance of the policy management system 104 adds a new instance of policy data to a corresponding instance of the policy database 106 and obtains a key 114 for the newly-added instance of policy data from the key generator 118, the instance of the policy management system 104 can provide the key 114 for the newly-added instance of policy data to the resolver 110, along with the instance identifier 116 associated with the instance of the policy management system 104. Accordingly, the resolver 110 can update the lookup table 112 to add the pairing of the new key 114 and the instance identifier 116.

As an example, when policy management system instance 104B added a new instance of policy data to policy database 106B, the key generator 118 may have indicated that the third key (“Policy 3”) was to be associated with the new instance of policy data added to policy database 106B. The policy management system instance 104B can accordingly have informed the resolver 110 that the third key (“Policy 3”) is associated with the instance identifier associated with policy management system instance 104B (“Instance B”). The resolver 110 can accordingly have updated the lookup table 112 to add the pairing of the third key (“Policy 3”) and the instance identifier associated with policy management system instance 104B (“Instance B”), as shown in FIG. 1.

Different instances of the policy management system 104 in different clusters 102, and/or elements of the clusters 102 or the instances of the policy database 106, can be configured differently. As an example, different instances of the policy management system 104, different clusters 102, and/or different instances of the policy database 106 may be configured differently for different software testing purposes. As another example, different instances of the policy management system 104, different clusters 102, and/or different instances of the policy database 106 may be configured differently based on different rules or regulations, different configuration preferences or settings, different policy data schemas, and/or other differing attributes. In some examples, the different instances of the policy management system 104 in different clusters 102 may be based on the same version and/or codebase of the policy management system 104, but may be configured differently. In other examples, the different instances of the policy management system 104 in the different clusters 102 may be based on different versions of the policy management system 104.

As an example, policy management system instance 104A may be configured to perform operations on policy data based on rules and regulations for the state of Illinois, while policy management system instance 104B may be configured to perform similar or different operations on policy data based on rules and regulations for the state of Ohio. Accordingly, testing and/or execution of software operations that may be impacted by Illinois rules and regulations can be performed in association with policy management system instance 104A, while testing and/or execution of software operations that may be impacted by Ohio rules and regulations can instead be performed in association with policy management system instance 104B.

As another example, policy management system instance 104A may be configured to display user interface elements designed for use by insurance agents, while policy management system instance 104B may be configured to display user interface elements designed for use by policyholders associated with insurance policies. Accordingly, testing and/or execution of software operations that may be associated with user interface elements for insurance agents can be performed in association with policy management system instance 104A, while testing and/or execution of software operations that may be associated with user interface elements for policyholders can instead be performed in association with policy management system instance 104B.

As yet another example, policy management system instance 104A and policy management system instance 104B can be configured to operate based on differently-set system clocks. For instance, a system clock associated with cluster 102A and/or policy management system instance 104A can be set to the current date, while a system clock associated with cluster 102B and/or policy management system instance 104B can be set to a date that is six months in the future. Accordingly, testing of software operations that may be expected to occur on the current date can be performed in association with policy management system instance 104A, while testing of software operations that may be expected to occur in six months (such as operations associated with a future renewal of an insurance policy) can instead be performed in association with policy management system instance 104B.

In still other examples, the different instances of the policy management system 104, and/or elements of the corresponding clusters 102 or corresponding instances of the policy database 106, can be configured differently in any other way. For instance, different instances of the policy management system 104 and/or the policy database 106 may be configured to use and/or store policy data using different schemas, may be configured to use and/or store policy data associated with different types of insurance policies, may be configured execute on different platforms, hardware types, and/or computing environments associated with different clusters 102, or may have other configurations such that different instances of the policy management system 104 in the clusters 102 may be incompatible with one another.

In some examples, the computing environment 100 may be a test environment that includes a test manager 120. The test manager 120 may manage and/or execute software tests in association with different instances of the policy management system 104 in the clusters 102. As discussed further below, the test manager 120 may execute tests that invoke one or more services 108, and that cause invoked services 108 to interact with different instances of the policy management system 104 to access policy data stored in different instances of the policy database 106. The invoked services 108 can communicate with the resolver 110 to determine which instances of the policy management system 104 to contact in order to access instances of policy data that are associated with corresponding software tests.

In some examples, the test manager 120 can cause policy data that will be used or accessed by particular instances of the policy management system 104, and/or one or more services 108, during execution of one or more software tests to be added to particular instances of the policy database 106. For example, if a particular software test is designed to test operations associated with a particular instance of the policy management system 104, for instance based on a configuration of that particular instance of the policy management system 104 that may be different from configurations of other instances of the policy management system 104, the test manager 120 can cause policy data associated with the particular software test to be stored in the instance of the policy database 106 that corresponds with the particular instance of the policy management system 104.

Adding an instance of policy data to a policy database can cause a corresponding instance of the policy management system 104 to obtain a key 114 for the instance of policy data from the key generator 118, and to provide the key 114 and an instance identifier 116 of the instance of the policy management system 104 to the resolver 110 as discussed above. Accordingly, the resolver 110 can update the lookup table 112 to include a pairing of the key 114 and the instance identifier 116 provided by the instance of the policy management system 104. The instance of the policy management system 104 can also provide the key 114 associated with the policy data to the test manager 120, such that the test manager 120 can use the key 114 to invoke one or more of the services 108 to access the policy data based on the corresponding key 114 during execution of a software test.

As an example, as discussed above, policy management system instance 104A may be configured to perform operations based on Illinois rules and regulations, while policy management system instance 104B may be configured to perform operations based on Ohio rules and regulations. In this example, if a particular software test is designed to test operations that are based on Illinois rules and regulations, the test manager 120 may cause policy management system instance 104A to add policy data that will be used and/or accessed during the particular software test to the policy database 106A. Accordingly, policy data relevant to the particular software test associated with Illinois rules and regulations can be stored in policy database 106A, but be omitted from policy database 106B. The lookup table 112 associated with the resolver 110 can also be updated to indicate that the policy data relevant to the particular software test can be accessed via policy management system instance 104A and not via policy management system instance 104B or any other instance of the policy management system 104.

The test manager 120 may have a front-end, such as a web page or other user interface, an application programming interface (API), and/or other system that can be used by a software developer or other user to set up and manage software tests. The test manager 120 can, for example, allow a software developer to input, upload, or define policy data associated with a software test, code and/or other data associated with the software test, and/or other information. The test manager 120 can also allow the software developer to select a particular instance of the policy management system 104 that is to be associated with the software test, for instance based on a configuration of the selected instance of the policy management system 104 that is associated with the software test. Accordingly, the test manager 120 can cause the user-selected instance of the policy management system 104 to store the policy data associated with the software test in the instance of the policy database 106 that corresponds with the user-selected instance of the policy management system 104.

In some examples, the resolver 110 may have default load balancing functions that are configured to automatically select which of the clusters 102 should be assigned to store new instances of policy data. However, because a user can use the test manager 120 to select a particular instance of the policy management system 104 that is to be associated with a particular software test as described above, the test manager 120 can override default load balancing functions of the resolver 110 and cause the particular user-selected instance of the policy management system 104 to store policy data associated with the software test in a corresponding instance of the policy database 106 as described above.

The test manager 120 can also initiate execution of software tests that are associated with particular instances of policy data stored in association with particular instances of the policy management system 104. Execution of such software tests may invoke one or more of the services 108 to access relevant policy data via corresponding instances of the policy management system 104 that may be configured differently.

However, although different instances of the policy management system 104 may be configured differently in the computing environment 100 for testing purposes, the services 108 may be production services or other services that are not configured specifically for testing purposes. Accordingly, the resolver 110 can allow such services 108 to be used during software testing, in association with differently-configured instances of the policy management system 104, without any changes to the services 108.

As an example, the services 108 may include a policy renewal system that is configured to automatically renew insurance policies based on policy data accessed via instances of the policy management system 104. The policy renewal system may be a production policy renewal system that is configured to use the resolver 110 to determine which instance of the policy management system 104 can be used to access a particular instance of policy data, so that the policy renewal system can renew a corresponding insurance policy based on accessing and/or editing the instance of policy data in an instance of the policy database 106. In production, the policy renewal system may accordingly use the resolver 110 to access real instances of policy data associated with real insurance policies from production instances of the policy management system 104 and/or production instances of the policy database 106. In some examples, such production instances of the policy management system 104 and/or the policy database 106 may be in other clusters 102 that are separate from clusters 102 of the testing environment.

However, the same production policy renewal system can be invoked during a software test, by the test manager 120 and/or other elements that execute the software test, to automatically perform policy renewal operations based on a test instance of profile data. Accordingly, although in some examples the production policy renewal system may not have information indicating that policy renewal operations associated with a particular insurance policy are to be performed as part of a software test, the software test can invoke the production policy renewal system to renew the insurance policy based on an instance of profile data associated with a key 114. The production policy renewal system can use the key 114 to query the resolver 110 and to receive an instance identifier 116 of the instance of the policy management system 104, in the testing environment, that can provide the instance of profile data associated with the key 114 to the production policy renewal system. The production policy renewal system can use the instance identifier 116 returned by the resolver 110 to access the corresponding instance of the policy management system 104 in the testing environment, and obtain the instance of profile data associated with the key 114.

In this example, the production policy renewal system can use instance identifiers 116 returned by the resolver 110 to access any of the differently-configured instances of the policy management system 104 in the testing environment, as if the instances of the policy management system 104 in the testing environment were production instances of the policy management system 104. The production policy renewal system can accordingly interact with differently-configured instances of the policy management system 104 in the testing environment during execution of software tests, without any changes to the production policy renewal system itself.

As an example, a system clock associated with cluster 102A and/or policy management system instance 104A may be set to the current date, and a system clock associated with cluster 102B and/or policy management system instance 104B may be set to a date that is six months in the future. In this example, a first software test designed to test a current renewal of an insurance policy may be based on first policy data stored in policy database 106A. The first software test can invoke the production policy renewal system to, by querying the resolver 110 based on a first key associated with the first policy data stored in policy database 106A, interact with policy management system instance 104A to access the first policy data and perform renewal operations associated with the first policy data based at least in part on the system clock set to the current date.

However, in this example, a second software test designed to test a future renewal of an insurance policy may be based on second policy data stored in policy database 106B. The second software test can invoke the production policy renewal system to, by querying the resolver 110 based on a second key associated with the second policy data stored in policy database 106B, interact with policy management system instance 104B to access the second policy data and perform renewal operations associated with the second policy data based at least in part on the system clock set to the future date. In this example, the same production policy renewal system can perform renewal operations based at least in part on different system clock dates by being directed by the resolver 110 to different instances of the policy management system 104 that are associated with the different system clock dates, without the production policy renewal system itself being changed or reconfigured for different test scenarios.

As another example, policy management system instance 104A may be configured to perform operations based on Illinois rules and regulations, while policy management system instance 104B may be configured to perform operations based on Ohio rules and regulations. In this example, a first software test designed to test a renewal of an insurance policy based on Illinois rules and regulations may be based on first policy data stored in policy database 106A. The first software test can invoke the production policy renewal system to, by querying the resolver 110 based on a first key associated with the first policy data stored in policy database 106A, interact with policy management system instance 104A to access the first policy data and perform renewal operations associated with the first policy data based at least in part on Illinois rules and regulations that policy management system instance 104A is configured to use.

However, in this example, a second software test designed to test a renewal of an insurance policy based on Ohio rules and regulations may be based on second policy data stored in policy database 106B. The second software test can invoke the production policy renewal system to, by querying the resolver 110 based on a second key associated with the second policy data stored in policy database 106B, interact with policy management system instance 104B to access the second policy data and perform renewal operations associated with the second policy data based at least in part on Ohio rules and regulations that policy management system instance 104B is configured to use. In this example, the same production policy renewal system can perform renewal operations based at least in part on rules and regulations of different states by being directed by the resolver 110 to different instances of the policy management system 104 that are configured to use the rules and regulations of the different states, without the production policy renewal system itself being changed or reconfigured for different test scenarios.

Although the services 108 may be production services in some examples, as described above, in other examples the services 108 can be test instances of the services 108 that are set up to be used in association with software tests. However, because the same test instances of the services 108 can be directed by the resolver 110 to any of the clusters 102 and corresponding differently-configured instances of the policy management system 104 as described herein, the same test instances of the services 108 can perform operations in association with instances of the policy management system 104 that are configured for different test scenarios, without the same test instances of the services 108 themselves being changed or reconfigured for different test scenarios.

In some examples, different sets of clusters 102 can be associated with different test lanes, test groups, and/or other elements. For example, a first set of clusters 102 containing a first set of differently-configured instances of the policy management system 104 can be set up for use during software testing by a first set of software developers, while a second set of clusters 102 containing a second set of differently-configured instances of the policy management system 104 can be set up for use during software testing by a second set of software developers. In this example, different instances of the policy management system 104 in the first set of clusters 102 may be configured differently for a first set of testing scenarios being tested by the first set of software developers, and different instances of the policy management system 104 in the second set of clusters 102 may be configured differently for a second set of testing scenarios being tested by the second set of software developers.

Although the computing environment 100 may be a testing environment in some examples, as discussed above, the computing environment 100 may also, or alternatively, be or include a production environment. In the production environment, production instances of the services 108 can use the resolver 110 to determine which of multiple differently-configured instances of the policy management system 104 to interact with in association with different policy data.

As an example, policy management system instance 104A may be configured to perform operations based on Illinois rules and regulations, while policy management system instance 104B may be configured to perform operations based on Ohio rules and regulations. In this example, a production service 108 may be configured to perform operations on policy data by interacting with instances of the policy management system 104. Accordingly, if the production service 108 is operating on a first insurance policy associated with the state of Illinois, the production service 108 may provide a policy identifier of the first insurance policy, or other key 114 associated with first insurance policy, to the resolver 110. The resolver 110 may return the instance identifier 116 of policy management system instance 104A to the production service 108, such that the production service 108 can use that instance identifier 116 to interact with policy management system instance 104A in association with the policy data for the first insurance policy.

However, in this example, if the production service 108 is operating on a second insurance policy associated with the state of Ohio, the production service 108 may provide a policy identifier of the second insurance policy, or other key 114 associated with second insurance policy, to the resolver 110. The resolver 110 may return the instance identifier 116 of policy management system instance 104B to the production service 108, such that the production service 108 can use that instance identifier 116 to interact with policy management system instance 104B in association with the policy data for the second insurance policy. In this example, the same production service 108 can perform operations based at least in part on rules and regulations of different states by being directed by the resolver 110 to different instances of the policy management system 104 that are configured to use the rules and regulations of the different states, without the production service 108 itself being changed or reconfigured for different test scenarios.

Overall, services 108 can use the resolver 110 to access policy data from any instance of the policy management system 104. Accordingly, the same services 108 can interact with instances of the policy management system 104 that are configured differently for different purposes, without the services 108 themselves being changed or reconfigured for those different purposes. As an example, the same services 108 can be invoked during software tests to interact with different instances of the policy management system 104 that have been configured for different test scenarios or testing purposes based on instance identifiers 116 provided by the resolver 110, without those services 108 being directly changed or reconfigured for the different test scenarios or testing purposes. As another example, services 108 may use the instance identifiers 116 provided by the resolver 110 to interact with differently-configured instances of the policy management system 104 during production operations or other situations, without the services 108 themselves being directly changed or reconfigured. The resolver 110 can therefore reduce usage of memory, processing cycles, and/or other computing resources relative to other systems in which the services 108 may be directly reconfigured for different purposes, such as different test scenarios, testing purposes or production situations, and/or relative to other systems in which different instances of services 108 configured for different test scenarios, testing purposes, or production systems may be created and executed separately.

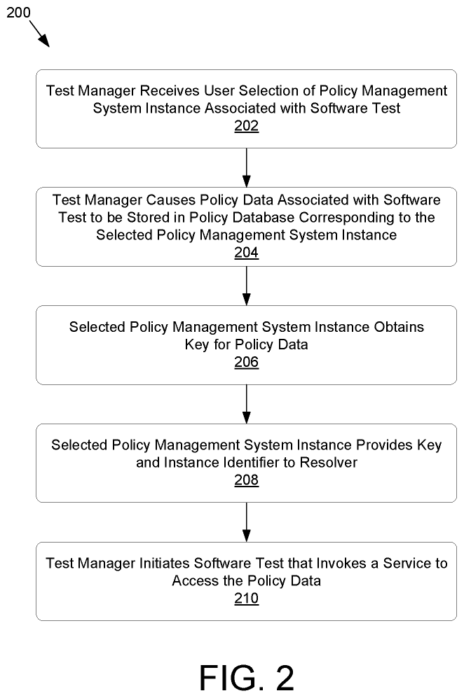

FIG. 2 shows a flowchart illustrating an example method 200 for setting up a software test that invokes at least one service 108 to interact with a particular instance of the policy management system 104. As discussed above, different instances of the policy management system 104, associated with different clusters 102, can be configured differently for different testing purposes or test scenarios. The method 200 shown in FIG. 2 can be performed by a computing system that is configured to execute the test manager 120 and/or the particular instance of the policy management system 104. An example system architecture for such a computing system is described below with respect to FIG. 5.

At block 202, the test manager 120 can receive a user selection of the particular instance of the policy management system 104 that is to be associated with the software test. As discussed above, the test manager 120 may have a user interface by which a user, such as software developer, can select the particular instance of the policy management system 104 that should be invoked during the software test.

At block 204, the test manager 120 can cause policy data, associated with the software test, to be stored in the instance of the policy database 106 that corresponds with the instance of the policy management system 104 selected at block 202. For example, the test manager 120 may provide the policy data to the selected instance of the policy management system 104, such that the selected instance of the policy management system 104 stores the policy data in the instance of the policy database 106 that is associated with the selected instance of the policy management system 104 and is within the same cluster 102 as the selected instance of the policy management system 104. The policy data provided at block 204 may be data that will be used or accessed during execution of the software test.

In some examples, the test manager 120 may provide the policy data to the selected instance of the policy management system 104 in part by informing the resolver 110 that the policy data will be added to the instance of the policy database 106 that corresponds with the instance of the policy management system 104 selected at block 202. This may override default operations of the resolver 110 that may otherwise select an instance of the policy management system 104 to be associated with new policy data.

At block 206, the selected instance of the policy management system 104 can obtain a key 114 for the policy data provided at block 204 from the key generator 118. As described above, the key generator 118 can provide a unique key for the policy data that is not used for any other policy data stored in any of the clusters 102.

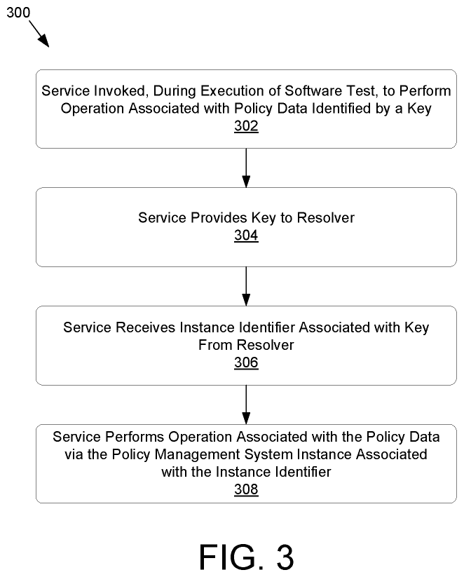

At block 208, the selected instance of the policy management system 104 can provide the key 114 for the new policy data obtained at block 206, and an instance identifier 116 associated with the selected instance of the policy management system 104, to the resolver 110. The resolver 110 can use the pair of the key 114 and the instance identifier 116, provided at block 208, to update the lookup table 112. The selected instance of the policy management system 104 can also provide the key 114 associated with the policy data to the test manager 120. Accordingly, the test manager 120 can later use the key 114 to invoke one or more services 108 to access the policy data based on the corresponding key 114 during execution of the software test, for example as discussed further below with respect to FIG. 3.

At block 210, the test manager 120 can initiate execution of the software test. Execution of the software test may invoke at least one of the services 108 to access the policy data associated with the software test that was provided at block 204, for instance by interacting with the instance of the policy management system 104 selected at block 202. The service 108 can interact with the resolver 110 to identify that the policy data associated with the software test can be accessed via the instance of the policy management system 104 selected at block 202, as discussed further below with respect to FIG. 3.

FIG. 3 shows a flowchart illustrating an example method 300 by which a service 108 can, during a software test, perform an operation associated with policy data via an instance of the policy management system 104 that has been configured for the software test. Although the instance of the policy management system 104 may have been configured for the software test, in some examples the service 108 can be a production instance of the service or another instance of the service that has not been reconfigured for the software test. In other examples, the service 108 may be a test instance of a service. As discussed above, different instances of the policy management system 104, associated with different clusters 102, can be configured differently for different testing purposes or test scenarios. Accordingly, the service 108 can use example method 300 when the service 108 is invoked during any software test associated with any testing scenario in order to communicate with different instances of the policy management system 104 that have been configured for different testing scenarios, without the service 108 itself being reconfigured for different testing scenarios. The method 300 shown in FIG. 3 can be performed by a computing system that is configured to execute a service 108. An example system architecture for such a computing system is described below with respect to FIG. 5.

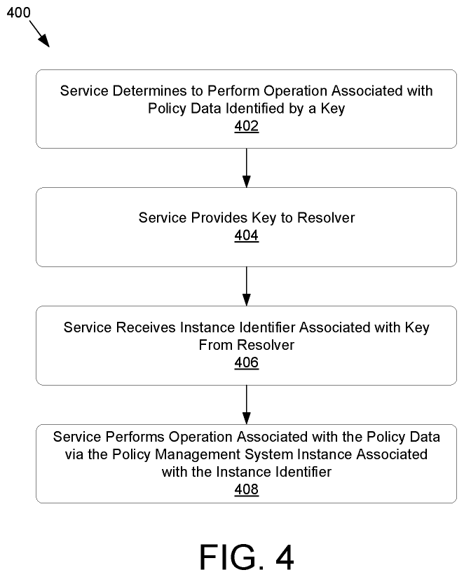

At block 302, the service 108 can be invoked during execution of a software test. The software test may have been initiated via the test manager 120, for example as discussed above with respect to FIG. 4. Execution of the software test can invoke the service 108 to perform one or more operations associated with policy data, identified by a key 114 defined in the software test or determined via other parts of the software test, via a corresponding instance of the policy management system 104. For example, the service 108 may be invoked to access and/or edit the policy data during the software test, to cause the instance of the policy management system 104 to perform one or more operations associated with the policy data, and/or to otherwise perform one or more operations based at least in part on the policy data identified by the key 114.

At block 304, the service 108 can provide the key 114 associated with the policy data to the resolver 110. For example, the service 108 can send a query request, identifying the key, to the resolver 110 at block 304.

At block 306, the service 108 can receive an instance identifier 116 from the resolver 110 that, based on the lookup table 112 of the resolver 110, is associated with the key 114 provided at block 304. For example, in response to the query request sent at block 304, the resolver 110 can return a response to the service 108 that indicates the instance identifier 116 that corresponds to the key 114 identified in the query request.

The instance identifier 116 returned at block 306 can be an identifier of a particular instance of the policy management system 104, or a particular cluster 102 that executes the particular instance of the policy management system 104, that the service 108 can interact with in association with the policy data that corresponds to the key 114. For example, if the key 114 provided at block 304 is associated with policy data stored in policy database 106B, the lookup table 112 can accordingly associate the key 114 with an instance identifier 116 for policy management system instance 104B and/or cluster 102B, which corresponds with policy database 106B.

In some examples, the instance identifier 116 provided at block 306 can be a URL or other address or identifier by which the service 108 can access and/or interact with the instance of the policy management system 104 that is associated with the instance identifier 116. For example, different clusters 102, and/or different instances of the policy management system 104, can be associated with different domains, domain names, IP addresses, and/or other identifiers. The resolver 110 can accordingly provide the service 108 with a URL, IP address, or other identifier that corresponds with the particular the instance of the policy management system 104 that, according to the lookup table 112, is associated with the key 114 for the policy data provided by the service 108 at block 304.

At block 308, the service 108 can use the instance identifier, provided by the resolver at block 306, to perform one or more operations associated with the policy data via the instance of the policy management system 104 that corresponds to the instance identifier 116. For example, the service 108 can use a provided URL to access the instance of the policy management system 104, and can use the key 114 associated with the policy data to request and/or obtain the policy data from the instance of the policy management system 104, to cause the instance of the policy management system 104 to perform one or more actions associated with the policy data, and/or to perform any other operations associated with the policy data during the software test.

As discussed above, different instances of the policy management system 104 can be configured differently for different testing purposes or test scenarios. Accordingly, at a first time, the service 108 may use the method 300 when invoked during a first software test to perform an operation based on first policy data via a first instance of the policy management system 104 that has been configured based on a first test scenario. However, at a second time, the same service 108 may use the method 300 when invoked during a second software test to perform the operation based on second policy data via a second instance of the policy management system 104 that has been configured based on a second test scenario.

Accordingly, although the service 108 itself may have the same configuration during both software tests, the service 108 may interact with the first instance of the policy management system 104 and the second instance of the policy management system 104 differently during the different software tests, based on the different configurations of the first instance of the policy management system 104 and the second instance of the policy management system 104. As an example, if the first instance of the policy management system 104 and the second instance of the policy management system 104 are configured with different system clock dates, data returned by the first instance of the policy management system 104 and the second instance of the policy management system 104 during the different software tests may cause the service 108 to perform differently due to the different system clock dates, even though the service 108 itself has not been reconfigured with different system clock dates.

FIG. 4 shows a flowchart illustrating an example method 400 by which a service 108 can perform an operation associated with policy data via an instance of the policy management system 104. As discussed above with respect to FIG. 3, the resolver 110 may be used during software tests to cause invoked services 108 to interact with instances of the policy management system 104 that are configured for the software tests. However, the resolver 110 may also be used in other situations, for example to allow a production service 108 to interact with multiple production instances of the policy management system 104 that are configured differently, without the service 108 itself being reconfigured. The method 400 shown in FIG. 4 can be performed by a computing system that is configured to execute a service 108. An example system architecture for such a computing system is described below with respect to FIG. 5.

At block 402, the service 108 can determine to perform one or more operations associated with policy data identified by a key 114. For example, the service 108 may be configured to perform one or more operations associated with an insurance policy as part of a batch process, or based on a trigger received from another service 108, a user command, or other instruction. The element that triggers the service 108 to perform the operation may provide, determine, or define the key 114 associated with the policy data for the insurance policy, such as a policy number of the insurance policy. The service 108 can be configured to perform the one or more operations, associated with the policy data identified by the key 114, via interactions with a corresponding instance of the policy management system 104. For example, the service 108 may be configured to access and/or edit the policy data, to cause the instance of the policy management system 104 to perform one or more operations associated with the policy data, and/or to otherwise perform one or more operations based at least in part on the policy data identified by the key 114.

At block 404, the service 108 can provide the key 114 associated with the policy data to the resolver 110. For example, the service 108 can send a query request, identifying the key, to the resolver 110 at block 404.

At block 406, the service 108 can receive an instance identifier 116 from the resolver 110 that, based on the lookup table 112 of the resolver 110, is associated with the key 114 provided at block 404. For example, in response to the query request sent at block 404, the resolver 110 can return a response to the service 108 that indicates the instance identifier 116 that corresponds to the key 114 identified in the query request.

The instance identifier 116 returned at block 406 can be an identifier of a particular instance of the policy management system 104, or a particular cluster 102 that executes the particular instance of the policy management system 104, that the service 108 can interact with in association with the policy data that corresponds to the key 114. For example, if the key 114 provided at block 304 is associated with policy data stored in policy database 106B, the lookup table 112 can accordingly associate the key 114 with an instance identifier 116 for policy management system instance 104B and/or cluster 102B, which corresponds with policy database 106B. In some examples, the instance identifier 116 provided at block 406 can be a URL or other address or identifier by which the service 108 can access and/or interact with the instance of the policy management system 104 that is associated with the instance identifier 116.

At block 408, the service 108 can use the instance identifier, provided by the resolver at block 406, to perform one or more operations associated with the policy data via the instance of the policy management system 104 that corresponds to the instance identifier 116. For example, the service 108 can use a provided URL to access the instance of the policy management system 104, and can use the key 114 associated with the policy data to request and/or obtain the policy data from the instance of the policy management system 104, to cause the instance of the policy management system 104 to perform one or more actions associated with the policy data, and/or to perform any other operations associated with the policy data.

As discussed above, different instances of the policy management system 104 can be configured differently for different purposes. For example, different instances of the policy management system 104 may be configured based on rules or regulations of different states, based on different schemas for policy data, and/or for other purposes. Accordingly, at a first time, the service 108 may use the method 400 to perform an operation based on first policy data via a first instance of the policy management system 104 that has a first configuration associated with rules of a first jurisdiction. However, at a second time, the same service 108 may use the method 400 to perform the operation based on second policy data via a second instance of the policy management system 104 that has a second configuration associated with different rules of a second jurisdiction. Accordingly, although the service 108 itself may have the same configuration at both the first time and the second time, the service 108 may interact with the first instance of the policy management system 104 and the second instance of the policy management system 104 differently at the first time and the second time, based on the different configurations of the first instance of the policy management system 104 and the second instance of the policy management system 104.

FIG. 5 shows an example system architecture 500 for a computing system 502 that can execute one or more elements associated with the computing environment 100 described herein. For example, the computing system 502 may execute elements associated with the clusters 102, the services 108, the resolver 110, the key generator 118, and/or the test manager 120. The computing system 502 can include one or more computers, servers, or other types of computing devices. Individual computing devices of the computing system 502 may have the system architecture 500 shown in FIG. 5, or a similar system architecture.

In some examples, elements associated with the computing environment 100 can be distributed among, and/or be executed by, multiple computing systems or devices similar to the computing system 502 shown in FIG. 5. As an example, different clusters 102 may be executed by different computing devices and/or computing systems. As another example, services 108 may be executed by different computing devices and/or computing systems than computing systems or devices that execute elements of the clusters 102, the resolver 110, the test manager 120, and/or other elements described herein.

The computing system 502 may, in some examples, be part of a cloud computing environment or other distributed system that hosts and/or executes one or more elements associated with the computing environment 100. For instance, a cloud computing environment may include multiple servers or other computing devices that can host one or more of the clusters 102, and/or that can host or execute one or more instances of the services 108, the resolver 110, the test manager 120, and/or other elements described herein. In some examples, the servers or other computing devices of such a cloud computing environment may use one or more virtual machines, containers, and/or other systems to execute one or more elements and/or instances of the computing environment 100.

The computing system 502 can include memory 504. In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 502. Any such non-transitory computer-readable media may be part of the computing system 502.

The memory 504 can store data, computer-executable instructions associated with software elements, firmware elements, or other executable elements, and/or other information. The memory 504 can store software or firmware elements, such as data and/or computer-readable instructions that are executable by one or more processors 508, associated with one or more elements described herein. For instance, the memory 504 can store computer-executable instructions and data associated with the computing environment 100. As a first example, the memory 504 may store computer-executable instructions and data associated with one or more clusters 102, such as instances of the policy management system 104 and the policy database 106. As a second example, the memory 504 may store computer-executable instructions and data associated with the resolver 110, such as the lookup table 112.

The memory 504 can also store other modules and data 506, such other modules and/or data that can be utilized by the computing system 502 to perform or enable performing any action taken by the computing system 502. Such other modules and data 506 can include a platform, operating system, and/or applications, as well as data utilized by the platform, operating system, and/or applications.

The computing system 502 can also have processor(s) 508, communication interfaces 510, a display 512, output devices 514, input devices 516, and/or a drive unit 518 including a machine readable medium 520.

In various examples, the processor(s) 508 can be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in the memory 504, which can be associated with types of volatile (RAM) and/or nonvolatile (ROM) memory.

The communication interfaces 510 can include transceivers, modems, network interfaces, antennas, and/or other components that can transmit and/or receive data over networks or other connections. In some examples, the communication interfaces 510 can be used to exchange data between elements described herein, such as communications between the clusters 102 and the resolver 110, the services 108 and the resolver 110, the services 108 and the clusters 102, the test manager 120 and the resolver 110, the test manager 120 and the services 108, the test manager 120 and clusters 102, and/or other types of communications.

The display 512 can be a liquid crystal display, or any other type of display commonly used in computing devices. The output devices 514 can include any sort of output devices known in the art, such as the display 512, speakers, a vibrating mechanism, and/or a tactile feedback mechanism. Output devices 514 can also include ports for one or more peripheral devices, such as headphones, peripheral speakers, and/or a peripheral display.

The input devices 516 can include any sort of input devices known in the art. For example, input devices 516 can include a microphone, a keyboard/keypad, and/or a touch-sensitive display, such as a touch-sensitive display screen. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 520 can store one or more sets of instructions, such as software or firmware, that embodies any one or more of the methodologies or functions described herein. The instructions can also reside, completely or at least partially, within the memory 504, processor(s) 508, and/or communication interface(s) 510 during execution thereof by the computing system 502. The memory 504 and the processor(s) 508 also can constitute machine readable media 520.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A software testing system, comprising:
a plurality of clusters, wherein different clusters in the plurality of clusters comprise:
different instances of a policy management system that are configured differently for different test scenarios; and
different instances of a policy database that store different sets of policy data;
a resolver that maintains a lookup table indicating associations between:
keys associated with policy data instances, and
instance identifiers, of the different instances of the policy management system, that correspond to the keys; and
a test manager that causes, during execution of a software test associated with a particular test scenario, a service executing outside the plurality of clusters to operate in association with particular policy data, associated with a key, via a particular instance of the policy management system that is configured based on the particular test scenario by:
providing, by the service, the key to the resolver;
receiving, by the service, and from the resolver based on the lookup table, a particular instance identifier corresponding to the particular instance of the policy management system; and
performing, by the service, and based on the particular instance identifier, an operation based on the particular policy data via the particular instance of the policy management system.

2. The software testing system of claim 1, wherein the different instances of the policy management system are configured differently, for the different test scenarios, based on different rules and regulations of different states.

3. The software testing system of claim 1, wherein the different instances of the policy management system are configured differently, for the different test scenarios, by being configured to present different user interface elements associated with different user types.

4. The software testing system of claim 1, wherein the different instances of the policy management system are configured differently, for the different test scenarios, by being configured to operate based on different system clock times.

5. The software testing system of claim 1, wherein the test manager is configured to add the particular policy data to an instance of the policy database that corresponds with the particular instance of the policy management system based on a user selection of the particular instance of the policy management system.

6. The software testing system of claim 5, wherein the user selection of the particular instance of the policy management system overrides a default selection by the resolver of an instance of the policy management system to be associated with the particular policy data.

7. The software testing system of claim 1, wherein:
the instance identifiers, of the different instances of the policy management system, are Uniform Resource Locators (URLs) at which the different instances of the policy management system are accessible, and
the particular instance identifier corresponding to the particular instance of the policy management system, provided by the resolver, is a particular URL associated with the particular instance of the policy management system.

8. The software testing system of claim 1, further comprising a key generator configured to generate the keys associated with the policy data instances stored in the different instances of the policy database across the plurality of clusters.

9. The software testing system of claim 1, wherein:
the service performs the operation, during different software tests, based on different instances of policy data via the different instances of the policy management system that are configured differently for the different test scenarios, and
the service uses a same configuration of the service, during the different software tests, to perform the operation based on the different instances of policy data via the different instances of the policy management system that are configured differently for the different test scenarios.

10. The software testing system of claim 1, wherein the different clusters are executed by different computing resources comprising at least one of:
different cloud computing elements,
different containers, or
different virtual machines.

11. A computer-implemented method, comprising:
configuring different instances of a policy management system based on different configurations, wherein the different instances of the policy management system are associated with different instances of a policy database that store different sets of policy data;
maintaining, by a resolver associated with the different instances of the policy management system, a lookup table that stores pairs of:
keys corresponding to instances of the policy data; and
instance identifiers of the different instances of the policy management system;
receiving, by the resolver, and from a service configured to interact with the different instances of the policy management system, a key corresponding to a particular policy data instance; and
providing, by the resolver, a particular instance identifier that is paired with the key in the lookup table,
wherein the particular instance identifier causes the service to perform at least one operation associated with the particular policy data instance via a particular instance of the policy management system that is associated with the particular instance identifier.

12. The computer-implemented method of claim 11, wherein the different configurations, of the different instances of the policy management system, are at least one of:
based on different rules and regulations of different states,
configure the different instances of the policy management system to present different user interface elements associated with different user types, or
configure the different instances of the policy management system to operate based on different system clock times.

13. The computer-implemented method of claim 11, wherein the different configurations are associated with different test scenarios.

14. The computer-implemented method of claim 13, wherein the particular instance of the policy management system is configured based on a particular test scenario, of the different test scenarios, and the method further comprises:
storing the particular policy data instance in an instance of the policy database that is associated with the particular instance of the policy management system; and
initiating a software test, associated with the particular test scenario, that invokes the service to:
provide the key to the resolver; and
perform the at least one operation via the particular instance of the policy management system that is associated with the particular instance identifier provided by the resolver.

15. The computer-implemented method of claim 11, wherein:
the instance identifiers, of the different instances of the policy management system, are Uniform Resource Locators (URLs) at which the different instances of the policy management system are accessible, and
the particular instance identifier is a particular URL associated with the particular instance of the policy management system.

16. One or more non-transitory computer-readable media storing computer-executable instructions that, when executed by one or more processors, cause the one or more processors to:
store policy data associated with a software test, corresponding to a test scenario, in an instance of a policy database associated with an instance of a policy management system configured based on the test scenario, wherein:
the instance of the policy management system is within a plurality of different instances of the policy management system that are configured differently for different test scenarios and are associated with different instances of the policy database, and
a key associated with the policy data is associated with an instance identifier of the instance of the policy management system within a lookup table maintained by a resolver associated with the plurality of different instances of the policy management system; and
initiate the software test, wherein the software test invokes a service and causes the service to perform an operation based on the policy data associated with the key by:
providing, by the service, the key to the resolver;
receiving, by the service, and from the resolver based on the lookup table, the instance identifier of the instance of the policy management system; and
performing, by the service, and based on the instance identifier, the operation based on the policy data via the instance of the policy management system.

17. The one or more non-transitory computer-readable media of claim 16, wherein the different instances of the policy management system are configured differently for the different test scenarios by at least one of:
being configured based on different rules and regulations of different states,
being configured to present different user interface elements associated with different user types, or
being configured to operate based on different system clock times.

18. The one or more non-transitory computer-readable media of claim 16, wherein the policy data is stored in the instance of the policy database, associated with the instance of the policy management system, based on a user selection of the instance of the policy management system that is configured based on the test scenario corresponding to the software test.

19. The one or more non-transitory computer-readable media of claim 16, wherein the lookup table maintained by the resolver stores associations between:
keys associated with policy data instances, and
instance identifiers of the different instances of the policy management system that store the policy data instances in corresponding instances of the policy database.

20. The one or more non-transitory computer-readable media of claim 16, wherein the computer-executable instructions further cause the one or more processors to initiate a second software test that invokes the service and causes the service to perform the operation based on second policy data, associated with a second key, by:
providing, by the service, the second key to the resolver;
receiving, by the service, and from the resolver based on the lookup table, a second instance identifier of a second instance of the policy management system that is configured for a different test scenario; and
performing, by the service, and based on the second instance identifier, the operation based on the second policy data via the second instance of the policy management system,
wherein the service uses a same configuration of the service, during the software test and the second software test, to perform the operation based on:
the policy data via the instance of the policy management system configured based on the test scenario, and
the second policy data via the second instance of the policy management system configured based on the different test scenario.
